(19) United States
(12) Patent Application Publication
(10) Pub. No.: US 2018/0372060 A1
(43) Pub. Date: Dec. 27, 2018

(54) AUTONOUMOUS POWER GENERATING DEVICE USING GRAVITY AND BUOYANCY, AUTONOMOUS POWER GENERATING DEVICE USING STRUCTURE, AND MARINE BOUNDARY LIGHT USING SAME

(71) Applicant: Min Shy JUNG, Gangneung-si (KR)

(72) Inventor: Min Shy JUNG, Gangneung-si (KR)

(21) Appl. No.: 15/776,396

(22) PCT Filed: Nov. 16, 2016
(86) PCT No.: PCT/KR2016/013210

§ 371 Date: May 15, 2018

(30) Foreign Application Priority Data
Nov. 16, 2015 (KR) 10-2015-0160375

(51) Int. Cl. F03B 13/18; B63B 35/44; F16H 19/06

(52) U.S. Cl. CPC F03B 13/186; B63B 22/166; F16H 19/06; B63B 35/44

(57) ABSTRACT

The present invention relates to an autonomous power generating device using gravity and buoyancy, an autonomous power generating device using a structure, and a marine boundary light using same. To this end, the present invention forms a rotating module having at least one rotating body provided on a rotating shaft and a power transmitting gear provided on one side end of the rotating shaft, a rope is hung to touch the rotating body of the rotating module and moves upward and downward, a buoyant body is provided on one side end of the rope, a tensioning body is provided on the other side end to vary the vertical force with the buoyant body, and the rotating force of the power transmitting gear of the rotating module is sequentially transmitted to a drive gear and a generator. Therefore, a fluctuation in water level can effectively be converted into an up-and-down vertical movement of the buoyant body.

### TECHNICAL FIELD

The present invention relates to an autonomous power generating device using gravity and buoyancy, and a marine boundary light using the same and more particularly, to an autonomous power generating device using gravity and buoyancy, and a marine boundary light using the same, in which an autonomous power generating device is formed by providing a rope which is hung to touch a rotating body of a rotating module so as to move upwards and downwards, a buoyant body which is provided on the end of one side of the rope, and a tensioning body which is provided on the end of the other side of the rope, the autonomous power generating device is provided to a buoyant structure, and the structure has a resistance panel which prevents an up-and-down flow and is provided with a buoyant column at the upper portion of the resistance panel and a gravitational part at the lower portion of the resistance panel, such that the structure is supported in a stable manner in the state in which the structure is buoyed.

### RELATED ART

In the past, thermal power plants using chemical energy of fossil fuels, hydroelectric power plants using potential energy of water in dams, nuclear power plants using nuclear fission of uranium generally produced electricity.

However, these days, the demand for the above-described power generation systems has decreased at a time when the issues of natural resource scarcity, safety and environmental protection draw public attention. We've seen a trend towards power generation systems using indefinite resources such as solar heat, tidal power, wave power, wind power, geothermal energy etc.

Further, water covers about 70% of the earth's surface. In particular, South Korea is abundant in energy provided by the sea because the country is surrounded by water in three sides. Accordingly, power generation devices using wave power have also attracted much attention in Korea.

However, there are problems with power generation systems using wave power. As a means to solve the problems, methods for easily installing a structure, supporting the structure in a stable manner despite the flow of water and effectively capturing the flow of water in different directions are needed.

Meanwhile, prior art documents related to this include Korean Patent No. 10-1510632 titled “WAVE POWER GENERATING APPARATUS” (registered on Apr. 3, 2015) and Korean Laid-Open Patent Publication No. 10-2014-0093913 titled “WAVE POWER GENERATING APPARATUS” (published on Jul. 29, 2014).

The prior art documents suggest that a horizontal movement is converted into a rotation movement, or an up-and-down (vertical) movement is converted into a rotation movement to generate electric energy.

However, according to the above-described prior art documents, building a structure in which a power generating apparatus is installed is money-consuming and is cost-ineffective. In addition, another problem is that it is hard to efficiently generate power due to water flowing in different directions.

Further, yet another problem is that if a member of the power generating apparatus is broken or damaged due to a complicated structure of the power generation apparatus, the power generating apparatus cannot efficiently generate power in response to the flow of water.

Meanwhile, a marine boundary light is installed in clean marine areas and marine farming areas as aids to navigation for helping vessels navigate safely, or is provided by using an object buoyed on the water to display locations of rocks, structures, vessels under the sea or to moor vessels, and equipped by using an anchor.

Such a marine boundary light is provided with light-emitting objects, the global positioning system (GPS) for pinpointing a position, communication devices for sending and receiving various signals, and a battery supplies electricity to these light-emitting objects, GPS, communication devices. However, batteries continue to be replaced with new ones, thereby causing inconvenience to users.

If power supplies fail, a serious marine accident would take place. Accordingly, it is important to supply even a small amount of power continuously.

### DETAILED DESCRIPTION OF THE INVENTION

### Technical Problems

The present invention is devised to solve the above-described problems. According to the present invention, provided is an autonomous power generating device using gravity and buoyancy, and a marine boundary light using the same which is capable of effectively converting the flow of water in different directions into an up-and-down (vertical) movement and capable of supporting a structure despite the flow of water. Also, provided is a power generating device with a simplified structure, thereby improving efficiency in management and repair.

### Technical Solutions

As a means to solve the above-described problems, an autonomous power generating device 20 using gravity and buoyancy according to the present invention is characterized in that at least one rotating body 21b is provided to a rotating shaft 21a and that a power transmitting gear 21c is provided at the end of one side of the rotating shaft 21a to form a rotating module 21, that a rope 22 is hung to touch the rotating body 21b of the rotating module 21 so as to move upwards and downwards, that the end of one side of the rope 22 has a buoyant body 23, that the end of the other side of the rope 22 has a tensioning body 24 having vertical force different from that of the buoyant body 23, and that rotating force of the power transmitting gear 21c of the rotating module 21 is consecutively transmitted to a drive gear 25 and a generator 26.

Further, the tensioning body 24 may be configured to be a gravitational body 24a sunk in fluid or a second buoyant body 24b buoyed on fluid.

Further, the rotating body 21b is configured to be a pinion gear, and a rack gear 22a formed at the rope 22 is hung to touch the rotating body to move upwards and downwards.

Further, the rope 22 is hung on and wound one or more laps around the rotating body 21b so as to move upwards and downwards.

Further, the rotating module 21 is provided at a location in which one or more first, second rotating bodies 21b-1, 21b-2 are respectively positioned to correspond to each other at a pair of first and second rotation shafts 21a-1, 21a-2 arranged in parallel with each other, a latch L is provided between the first, second rotating bodies 21b-1, 21b-2 and the first and second rotation shafts 21a-1, 21a-2 to transmit driving power in one direction having different directions, and rotating force of the first, second rotating bodies 21b-1, 21b-2 may be transmitted to the power transmitting gear 21c.

Further, the first, second rotating bodies 21b-1, 21b-2 respectively have a gear part 21b-3 such that the first, second rotating bodies engage with each other and that the gear part 21b-3 of the second rotating body 21b-1 engages with the power transmitting gear 21c, thereby transmitting the rotating force.

Meanwhile, an autonomous power generating device (SG) using a structure of the present invention is formed by providing a buoyant structure 10 with a power generating device 20, the structure 10 has a resistance panel 11 which prevents an up-and-down flow and is provided with a buoyant column 12 at the upper portion of the resistance panel 11 and a gravitational part 13 at the lower portion of the resistance panel 11, the power generating device 20 includes at least one rotating body 21b which is provided to a rotating shaft 21a and a power transmitting gear 21c which receives rotating force of the rotating body 21b to form a rotating module 21, a rope 22 is hung to touch the rotating body 21b of the rotating module 21 so as to move upwards and downwards, the end of one side of the rope 22 has a buoyant body 23, the end of the other side of the rope 22 has a tensioning body 24 having vertical force different from that of the buoyant body 23, and rotating force of the power transmitting gear 21c of the rotating module 21 is consecutively transmitted to a drive gear 25 and a generator 26 provided at the upper end of the buoyant column 12.

Further, the tensioning body 24 may be configured to be a gravitational body 24a sunk in fluid, and the rotating module 21 may be provided at the upper portion of the buoyant column 12.

Further, the tensioning body 24 is configured to be a second buoyant body 24b buoyed on fluid, and the rotating module 21 may be provided to the resistance panel 11.

Further, the rotating module 21 is provided at a location in which one or more first, second rotating bodies 21b-1, 21b-2 are respectively positioned to correspond to each other at a pair of first and second rotation shafts 21a-1, 21a-2 arranged in parallel with each other, a latch L is provided between the first, second rotating bodies 21b-1, 21b-2 and the first and second rotation shafts 21a-1, 21a-2 to transmit driving power only in one direction of an up- and down movement having different directions, and rotating force of the first, second rotating bodies 21b-1, 21b-2 may be transmitted to the power transmitting gear 21c.

Meanwhile, an autonomous power-generating boundary light of the present invention is formed by providing a buoyant structure 10 with a power generating device 20 and a lighting part 30, the structure 10 includes a resistance panel 11 which prevents an up-and-down flow and is provided with a buoyant column 12 at the upper portion of the resistance panel 11 and a gravitational part 13 at the lower portion of the resistance panel 11, the power generating device 20 includes at least one rotating body 21b which is provided to a rotating shaft 21a and a power transmitting gear 21c which receives rotating force of the rotating body 21b to form a rotating module 21, a rope 22 is hung to touch the rotating body 21b of the rotating module 21 so as to move upwards and downwards, the end of one side of the rope 22 has a buoyant body 23, the end of the other side of the rope 22 has a tensioning body 24 having vertical force different from that of the buoyant body 23, rotating force of the power transmitting gear 21c of the rotating module 21 is consecutively transmitted to a drive gear 25 and a generator 26 provided at the upper end of the buoyant column 12 to generate power, and the power is transmitted to the lighting part 30.

### Advantageous Effects

An autonomous power generating device using gravity and buoyancy of the present invention, and a marine boundary light using the same has a rope provided with a buoyant body and a tensioning body, which have different vertical force, at both ends of the rope so as to effectively convert the flow of water into an up-and-down (vertical) movement of the buoyant body.

Further, the rope is hung to touch first, second rotating bodies of a rotating module so as to move upwards and downwards. Accordingly, the structure of the power generating device may be simplified, thereby improving efficiency in management and repair.

Further, a structure for autonomous power generation is easily installed by providing a resistance panel for preventing an up-and-down flow to a structure, providing a buoyant column at the upper portion of the resistance panel, providing a gravitational part at the lower portion of the resistance panel and providing a power generating device to the structure.

Further, the buoyant column and the gravitational part are provided with respect to the resistance panel such that the structure is supported in a stable manner despite the flow of water.

In doing so, the structure is simply formed thereby ensuring efficient management and repair.

In addition, a marine boundary light continuously supplied with power may be provided.

### BRIEF DESCRIPTION OF THE INVENTION

FIG. 1 is a perspective view illustrating an autonomous power generating device using a gravitational body according to an embodiment of the present invention.

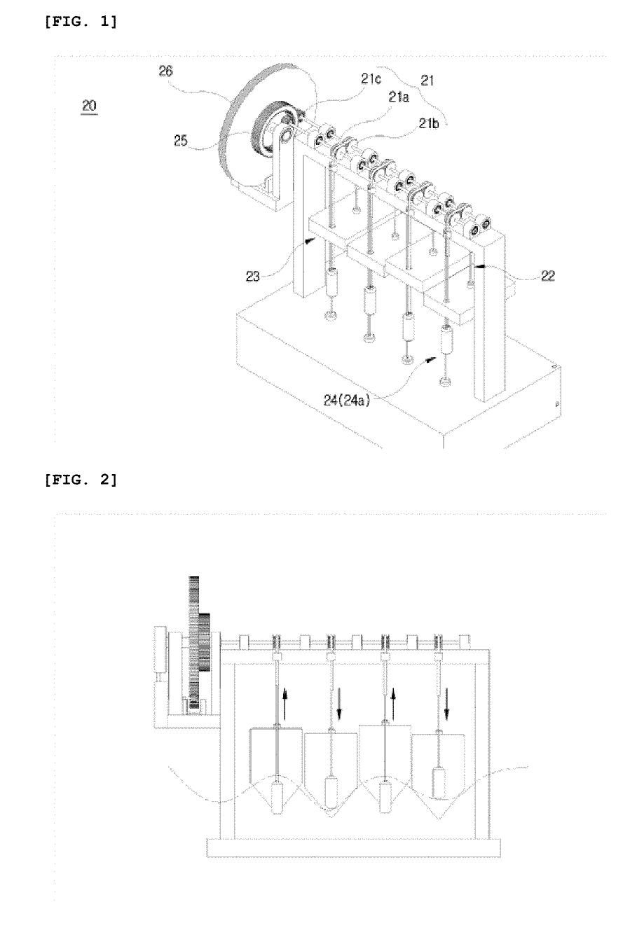

FIG. 2 is a conceptual diagram illustrating a theory about the operation of an autonomous power generating device using a gravitational body according to an embodiment of the present invention.

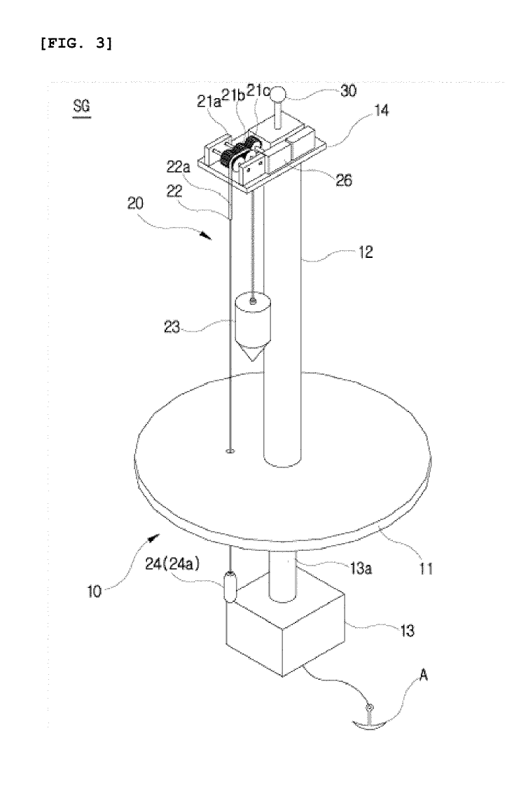

FIG. 3 is a perspective view illustrating an autonomous power generating device using a gravitational body provided to a buoyant structure of the present invention.

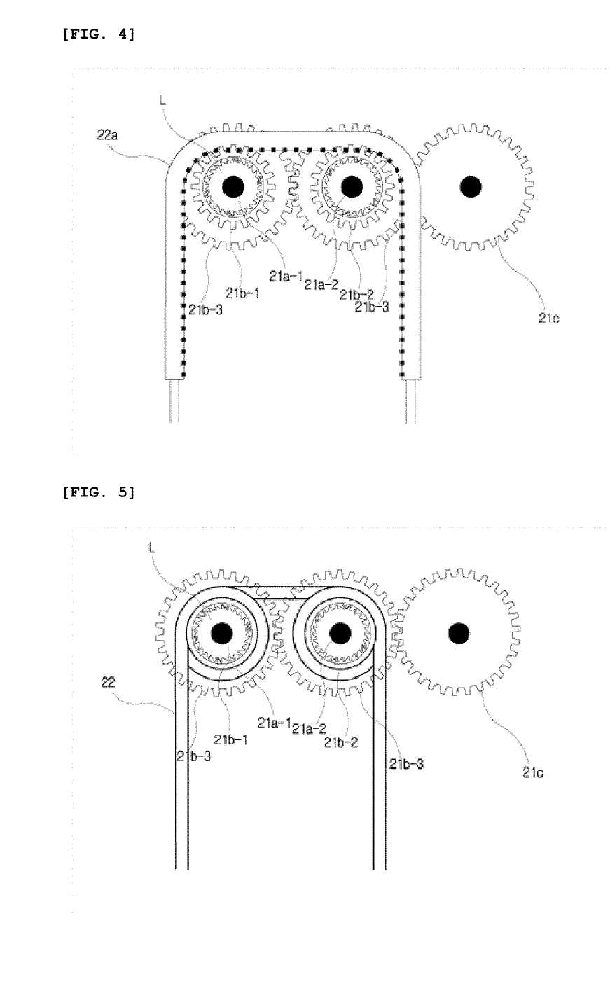

FIG. 4 is a conceptual diagram illustrating a relation between a rotating boy and a rope of an autonomous power generating device using a gravitational body according to an embodiment of the present invention.

FIG. 5 is a conceptual diagram illustrating a relation between a rotating boy and a rope of an autonomous power generating device using a gravitational body according to another embodiment of the present invention.

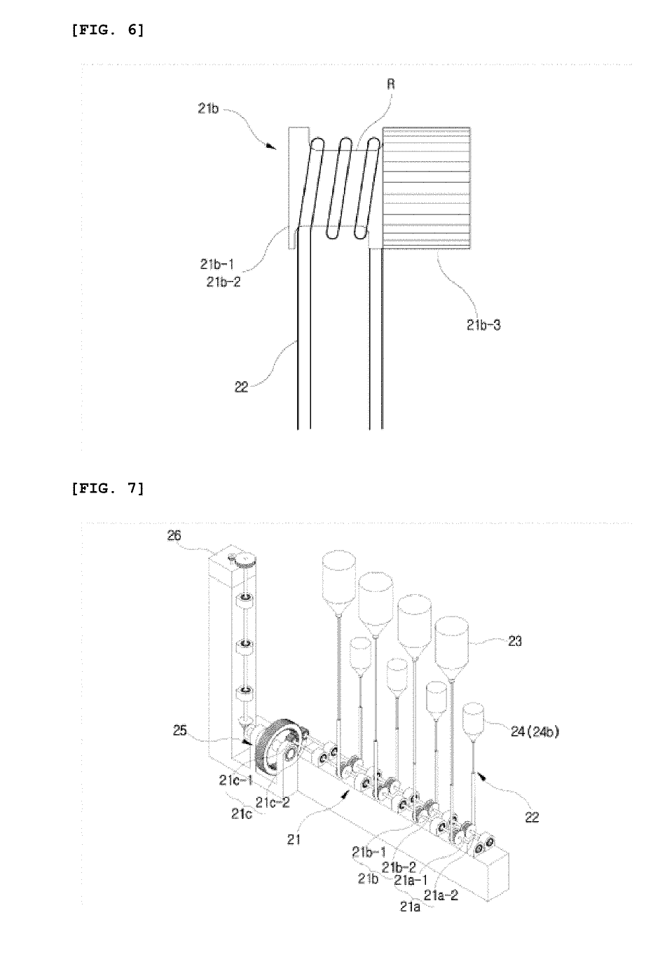

FIG. 6 is an elevation illustrating a relation between a rotating boy and a rope of an autonomous power generating device using a gravitational body according to another embodiment of the present invention.

FIG. 7 is a perspective view illustrating an autonomous power generating device using a buoyant body according to an embodiment of the present invention.

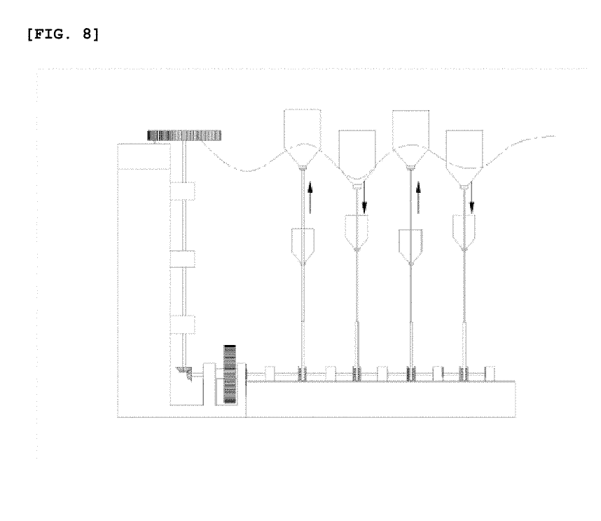

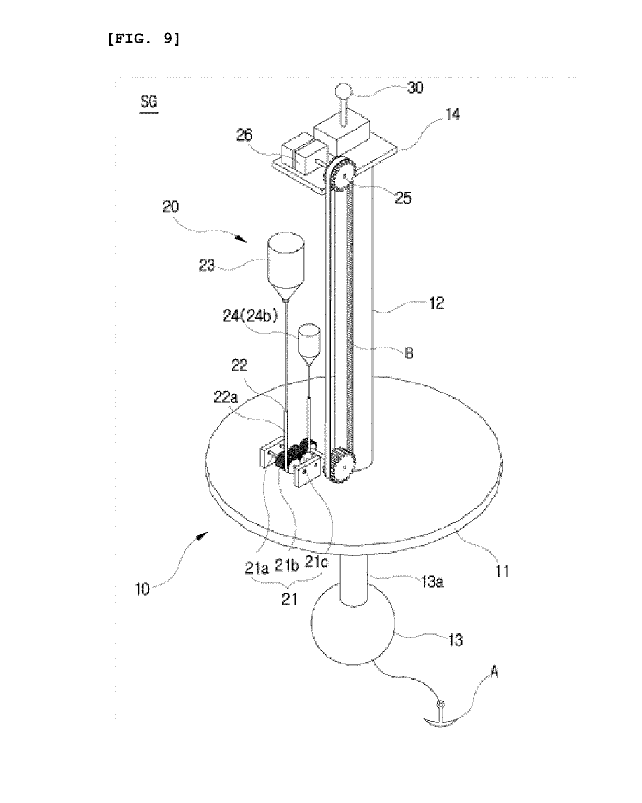

FIG. 8 is a conceptual diagram illustrating a theory about the operation of an autonomous power generating device using a buoyant body according to an embodiment of the present invention.

FIG. 9 is a perspective view illustrating an autonomous power generating device using a buoyant body provided to a buoyant structure of the present invention.

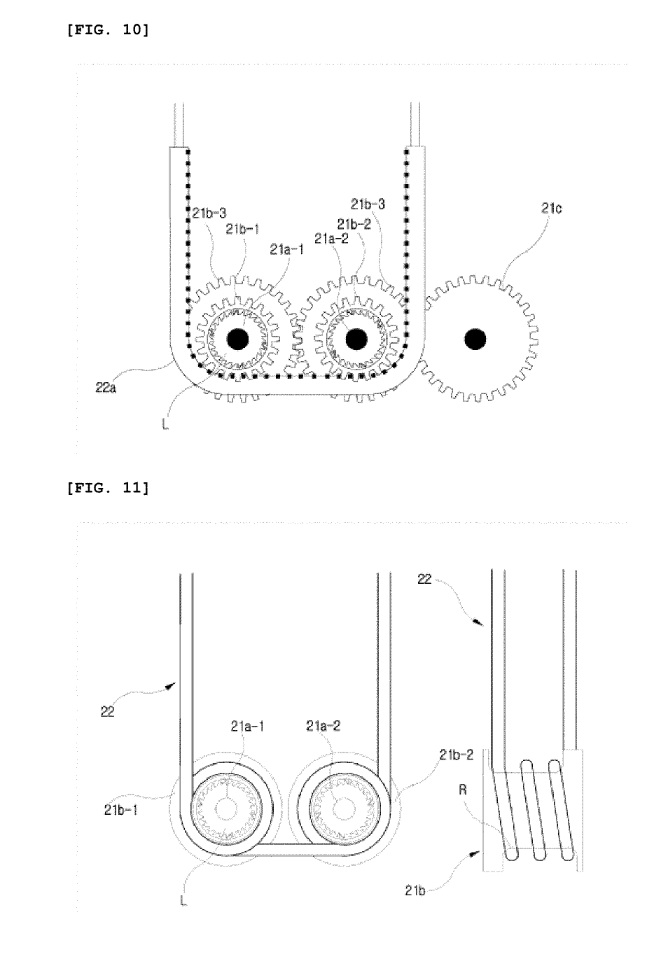

FIG. 10 is a conceptual diagram illustrating a relation between a rotating boy and a rope of an autonomous power generating device using a buoyant body according to an embodiment of the present invention.

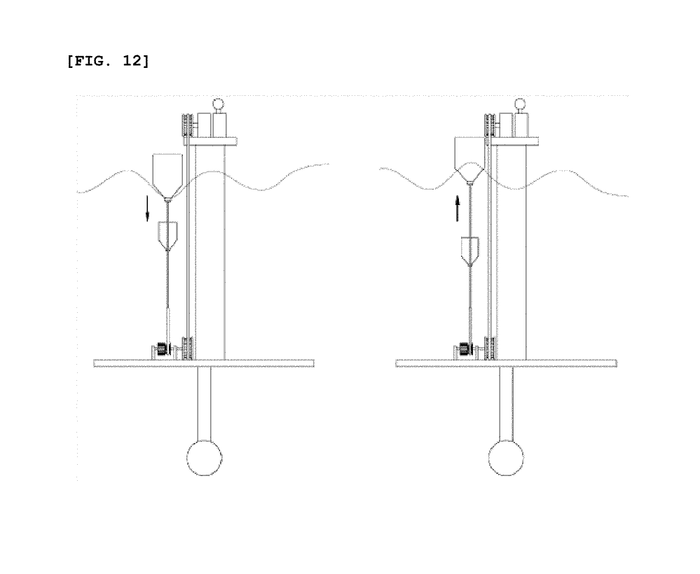

FIG. 11 is a conceptual diagram illustrating a relation between a rotating boy and a rope of an autonomous power generating device using a buoyant body according to another embodiment of the present invention.

FIG. 12 is a perspective view illustrating an autonomous power generating device using a tensioning body provided to a buoyant structure according to an embodiment of the present invention.

### MODE FOR CARRYING OUT THE INVENTION

Preferred embodiments of the present invention will be described in detail with reference to the attached drawings.

FIGS. 3 and 9 are perspective views illustrating an autonomous power generating device (SG) using a structure according to various embodiments of the present invention, and a buoyant structure 10 has a power generating device 20.

In detail, the structure 10 has a resistance panel 11 which prevents an up-and-down flow and is provided with a buoyant column 12 at the upper portion of the resistance panel 11 and a gravitational part 13 at the lower portion of the resistance panel 11.

The resistance panel 11 prevents the structure 10 from flowing upwards and downwards so as to keep the structure 10 at a certain position despite the flow of fluid. In this case, the buoyant column 12 has a hollow part so as to relatively ensure buoyancy, and the gravitational part 13 provided at the lower portion of the resistance panel has a weight body having relatively high density.

In doing so, the structure 20 may be effectively buoyed by means of the buoyant column 12 while standing perpendicularly by means of the gravitational part 13, may be kept at a certain position without making a big change in the position by means of the resistance panel 11 such that the power generating device (SG) 20 is supported in a stable manner and effectively generates power despite the flow of fluid.

It is possible to manufacture and use a resistance panel 11, which has enough buoyancy in itself, instead of the buoyant column 12.

In this case, the gravitational part 13 has a gravitational column 13a such that the structure 10 stands upright in a more stable manner and that the gravitational part 13 avoids being swept away and is easily kept at a certain position by means of an anchor A.

Meanwhile, as illustrated in FIGS. 1 and 7, a power generating device 20 of the present invention includes a rotating module 21, a rope 22 hung on the rotating module 21, a buoyant body 23 and a tensioning body 24 provided at both ends of the rope 22, a drive gear 25 to which the rotating force of the rotating module 21 is transmitted and a generator 26 which generates power on the basis of the rotating force.

In detail, the rotating module 21 is configured to convert an up-and-down (vertical) movement of the rope 22 into a rotation movement so as to transmit the rotating force to the drive gear 25, and configured to have a rotation shaft 21a which is provided with at least one rotating body 21b and a power transmitting gear 21c to which the rotating force of the rotating body 21b is transmitted.

The rotation shaft 21a may be provided at a location in which one or more first, second rotating bodies 21b-1, 21b-2 are respectively positioned to correspond to each other at a pair of first and second rotation shafts 21a-1, 21a-2 arranged in parallel with each other.

In this case, as illustrated in FIGS. 4 to 6 and FIGS. 10 to 11, a latch L is provided between the first, second rotating bodies 21b-1, 21b-2 and the first and second rotation shafts 21a-1, 21a-2 of the rotating module 21 to transmit driving power only in one direction of an up- and down direction having different directions, and rotating force of the first, second rotating bodies 21b-1, 21b-2 may be transmitted to the power transmitting gear 21c.

Meanwhile, according to the direction in which the rope 22 is wound around the first, second rotating bodies 21b-1, 21b-2, the first, second rotation shafts 21a-1, 21a-2 belonging to the first, second rotating bodies 21b-1, 21b-2 may rotate in the same direction or in different directions.

Though not illustrated in the drawings, the rotating body 21b and the rope 22 may be configured to include a plurality of rotating bodies and ropes. Each rotating body may rotate differently by means of an independent up-and-down (vertical) movement. Accordingly, each rotating body 21b may have a latch L such that each rotating body 21b independently transmits the rotating force to the rotation shaft 21a.

In this case, all the rotating force of the first, second rotating bodies 21b-1, 21b-2 is transmitted to the power transmitting gear 21c to generate power effectively, and rechargeable batteries are provided to continue to generate power in both directions.

Meanwhile, as illustrated in FIGS. 4 to 6 and FIGS. 10 to 11, the first, second rotating bodies 21b-1, 21b-2 respectively have a gear part 21b-3 such that the first, second rotating bodies engage with each other and that the gear part 21b-3 of the second rotating body 21b-1 engages with the power transmitting gear 21c, thereby transmitting the rotating force.

In doing so, the first, second rotating bodies 21b-1, 21b-2, respectively rotating in different directions, rotate so as to engage with each other in different directions. This makes the power transmitting gear 21c rotate in one direction.

In this case, as illustrated in FIG. 9, the power transmitting gear 21c and the drive gear 25 of the rotating module 21 use a belt B as a means to transmit driving power. And the belt may be configured to be a rack gear or a chain.

Meanwhile, as illustrated in FIGS. 1 to 2 and FIGS. 7 to 8, the buoyant body 23 performs an up-and-down (vertical) movement according to the flow of water and converts the vertical movement of the rope 20 into the rotation movement of the rotating body 21b.

In this case, the buoyant body 23 may be configured to have different types such as a spherical type, a flat type, a circular cylinder type, an inverted pyramid type, a circular cone type etc. Preferably, the buoyant body 23 consists of a column part, which has a circular cylinder shape or a polygonal column shape, and a cone part, which is formed at the lower portion of the column part and has a circular cone shape or a polygonal cone shape.

Further, the buoyant body 23 may have a fluid injection mouth and a fluid discharge mouth for injecting or discharging air or seawater etc. In doing so, the buoyant body may increase buoyance by injecting air or decrease buoyancy by injecting seawater as a means to control buoyance in the relation with the tensioning body 24. That is, the buoyant body may control buoyance by injecting or discharging air or seawater through the fluid injection mouth and fluid discharge mouth.

Further, the buoyant body 23 and the tensioning body 24 are provided to correspond to each other with respect to the buoyant column 12 so as to ensure the balance of an autonomous power generating device (GS).

Meanwhile, in the present invention, vertical force applied to the buoyant body 23 and the tensioning body 24 is defined as total force in which the value of gravity and buoyancy are added.

As illustrated in FIGS. 1 and 2, the tensioning body 24 is configured to be a gravitational body 24a sunk in fluid, and the rotating module 21 may be provided right at the upper portion of the buoyant column 12 and may be provided at an upper panel 14 formed at the upper portion of the buoyant column 12.

In detail, the gravitational body 24a applies a certain degree of tension to the rope 20 so as to prevent the buoyant column 23 from flowing left and right, and may be inserted into and installed in the buoyant column 12.

In this case, a guide hole may be formed at the upper panel 14 so as to guide the up-and-down movement of the rope 20. That is, the rope 20 penetrates the upper panel 14 such that the buoyant body 23 effectively performs a vertical movement.

An inclined surface or a curved surface may be formed at upper, lower portions of the gravitational body 24a. When moving upwards and downwards, the gravitational body 24a can move left and right due to resistance in the water. Accordingly, an inclined surface or a curved surface is preferably formed at the gravitational body 24a such that resistance caused by a shape of the gravitational body 24a is reduced and that the gravitational body 24a effectively moves.

Further, the gravitational body 24a is not always provided in the water. In some cases, the gravitational body 24a may be installed on the water.

Meanwhile, as illustrated in FIGS. 7 and 8, the tensioning body 24 is configured to be a second buoyant body 24b buoyed on fluid, and the rotating module 21 may be provided to the resistance panel 11.

The buoyant body 23 and the second buoyant body 24b are guided so as to perform a vertical movement effectively by means of a difference in buoyance despite flow of water in different directions. In detail, a certain degree of tension is applied to the rope 22 by means of a difference in buoyancy between the buoyant body 23 and the second buoyant body 24b so as to prevent the buoyant body 23 and the second buoyant body 24b from flowing left and right.

In this case, the second buoyant body 24b also increases buoyance by injecting air or decrease buoyancy by injecting seawater as a means to control buoyance. That is, the second buoyant body may control buoyance by injecting or discharging air or seawater through a fluid injection mouth and fluid discharge mouth.

Further, if the rotating module 21 is provided in the water, it is likely that salt corrodes the rotating module 21, or marine organisms or foreign substances are introduced into the rotating module 21. Accordingly, the resistance panel 11 of the structure 10 may have a cover so as to cover up the rotating module 21.

Meanwhile, as illustrated in FIGS. 4 and 10, the rotating body 21b provided to the rotating module 21 of the present invention is configured to be a pinion gear, and a rack gear 22a formed at the rope 22 is hung to touch the rotating body so as to move upwards and downwards.

In this case, the rack gear 22a may be replaced with a chain, and in terms of the configuration in which the up-and-down movement of a rope 22 may be transmitted to a rotating module 21, the configuration can be acquired on the basis of modifications made by those skilled in the art to which the present invention pertains. Accordingly, the configuration should be construed as being included in the scope of the present invention.

As yet another embodiment, as illustrated in FIGS. 5 to 6 and FIG. 11, the rope 22 is hung and wound one or more laps round the rotating body 21b so as to move upwards and downwards. In doing so, an up-and-down movement may be converted into a rotation movement by means of frictional force between the rope 22 and the rotating body 21b.

In this case, the rotating body 21b has a winding part R, and the rope 22 may be hung and wound one or more laps around the winding part R. In doing so, the rope 22 is prevented from escaping from the rotating body 21b and may effectively transmit driving power.

Meanwhile, a boundary light using an autonomous power generating device according to the present invention is formed by providing a buoyant structure 10 with a power generating device 20 and a lighting part 30.

In detail, rotating force of the power transmitting gear 21c is consecutively transmitted to the drive gear 25 and to the generator 26 provided at the upper end of the buoyant column 12 so as to generate power and the power may be provided to the lighting part 30.

A boundary light using an autonomous power generating device of the present invention may further has a rechargeable battery. Accordingly, the present invention may provide a marine boundary light to which power is continuously supplied in a stable manner despite the irregular flow of water.

Further, a boundary light using an autonomous power generating device of the present invention has a communication device and an image capture element. Accordingly, the present invention may have the additional effect of providing continuous management of and repair to an autonomous power generating device and a marine boundary light using the same.

An autonomous power generating device using gravity and buoyancy, an autonomous power generating device using a structure, and a marine boundary light using the same according to the present invention have been described. It is understandable that the technical configuration of the present invention may be embodied in other detailed forms within the technical spirit and essential features of the present invention by those skilled in the art to which the present invention pertains.

Therefore, it should be understood that the embodiments are provided as examples and that the present invention should not be construed as being limited to the embodiments set forth herein.

1. An autonomous power generating device using gravity and buoyancy, comprising:
at least one rotating body provided to a rotating shaft,
a power transmitting gear receiving rotating force of the rotating shaft, so as to form a rotating module, and
a rope hung to touch the rotating body of the rotating module so as to move upwards and downwards, wherein:
the end of one side of the rope has a buoyant body,
the end of the other side of the rope has a tensioning body having vertical force different from that of the buoyant body, and
rotating force of the power transmitting gear of the rotating module is consecutively transmitted to a drive gear and a generator.

2. The autonomous power generating device using gravity and buoyancy according to claim 1, wherein the tensioning body is configured to be a gravitational body sunk in fluid or a second buoyant body buoyed on fluid.

3. The autonomous power generating device using gravity and buoyancy according to claim 2, wherein the rotating body is configured to be a pinion gear, and a rack gear formed at the rope is hung to touch the rotating body so as to move upwards and downwards.

4. The autonomous power generating device using gravity and buoyancy according to claim 2, wherein the rope is hung on and wound one or more laps around the rotating body so as to move upwards and downwards.

5. The autonomous power generating device using gravity and buoyancy according to claim 3, wherein:
the rotating module is provided at a location in which one or more first, second rotating bodies are respectively positioned to correspond to each other at a pair of first and second rotation shafts arranged in parallel with each other,
a latch is provided between the first, second rotating bodies and first and second rotation shafts to transmit driving power in one direction having different directions, and
rotating force of the first, second rotating bodies may be transmitted to the power transmitting gear.

6. The autonomous power generating device using gravity and buoyancy according to claim 5, wherein:
the first, second rotating bodies respectively have a gear part such that the first, second rotating bodies engage with each other; and
the gear part of the second rotating body engages with the power transmitting gear, thereby transmitting the rotating force.

7. An autonomous power generating device comprising:
a structure in which a power generating device is provided to a buoyant structure, wherein the structure has a resistance panel which prevents an up-and-down flow and is provided with a buoyant column at the upper portion of the resistance panel and a gravitational part at the lower portion of the resistance panel, the power generating device comprising:
at least one rotating body which is provided to a rotating shaft and a power transmitting gear which receives rotating force of the rotating body to form a rotating module, and
a rope hung to touch the rotating body of the rotating module so as to move upwards and downwards, wherein:
the end of one side of the rope has a buoyant body,
the end of the other side of the rope has a tensioning body having vertical force different from that of the buoyant body, and
rotating force of the power transmitting gear of the rotating module is consecutively transmitted to a drive gear and a generator provided at the upper end of the buoyant column.

8. The autonomous power generating device using a structure according to claim 7, wherein the tensioning body is configured to be a gravitational body sunk in fluid, and the rotating module is provided at the upper portion of the buoyant column.

9. The autonomous power generating device using a structure according to claim 7, wherein the tensioning body is configured to be a second buoyant body buoyed on fluid, and the rotating module may be provided to the resistance panel.

10. The autonomous power generating device using a structure according to claim 8, wherein:
the rotating module is provided at a location in which one or more first, second rotating bodies are respectively positioned to correspond to each other at a pair of first and second rotation shafts arranged in parallel with each other,
a latch is provided between the first, second rotating bodies and the first and second rotation shafts to transmit driving power only in one direction of an up- and down movement having different directions, and
rotating force of the first, second rotating bodies may be transmitted to the power transmitting gear.

11. An autonomous power-generating boundary light comprising:
a structure in which a power generating device and a lighting part are provided to a buoyant structure, wherein the structure has a resistance panel which prevents an up-and-down flow and is provided with a buoyant column at the upper portion of the resistance panel and a gravitational part at the lower portion of the resistance panel, the power generating device comprising:
at least one rotating body which is provided to a rotating shaft and a power transmitting gear which receives rotating force of the rotating body to form a rotating module, and
a rope hung to touch the rotating body of the rotating module so as to move upwards and downwards, wherein:
the end of one side of the rope has a buoyant body,
the end of the other side of the rope has a tensioning body having vertical force different from that of the buoyant body, and
rotating force of the power transmitting gear of the rotating module is consecutively transmitted to a drive gear and a generator provided at the upper end of the buoyant column to generate power, and the power is transmitted to the lighting part.

12. The autonomous power generating device using gravity and buoyancy according to claim 4, wherein:
the rotating module is provided at a location in which one or more first, second rotating bodies are respectively positioned to correspond to each other at a pair of first and second rotation shafts arranged in parallel with each other,
a latch is provided between the first, second rotating bodies and first and second rotation shafts to transmit driving power in one direction having different directions, and
rotating force of the first, second rotating bodies may be transmitted to the power transmitting gear.

13. The autonomous power generating device using gravity and buoyancy according to claim 12, wherein:
the first, second rotating bodies respectively have a gear part such that the first, second rotating bodies engage with each other; and
the gear part of the second rotating body engages with the power transmitting gear, thereby transmitting the rotating force.

14. The autonomous power generating device using a structure according to claim 9, wherein:
the rotating module is provided at a location in which one or more first, second rotating bodies are respectively positioned to correspond to each other at a pair of first and second rotation shafts arranged in parallel with each other,
a latch is provided between the first, second rotating bodies and the first and second rotation shafts to transmit driving power only in one direction of an up- and down movement having different directions, and
rotating force of the first, second rotating bodies may be transmitted to the power transmitting gear.
